(19) United States
(12) Patent Application Publication
(10) Pub. No.: US 2010/0123513 A1
(43) Pub. Date: May 20, 2010

(54) INTERGRATED CIRCUIT FOR GENERATING INTERNAL VOLTAGE

(76) Inventor: Khil-Ohk KANG, Gyeonggi-do (KR)

Correspondence Address: IP & T Law Firm PLC, 7700 Little River Turnpike, Suite 207, Annandale, VA, 22003, US

(21) Appl. No.: 12/427,835

(22) Filed: Apr. 22, 2009

(30) Foreign Application Priority Data
Nov. 17, 2008 (KR) 10-2008-0113935

(51) Int. Cl. G05F 1/10

(52) U.S. Cl. 327/538

(57) ABSTRACT

An integrated circuit includes a driver configured to provide an internal voltage by driving an internal voltage node with an external voltage, a controller configured to output a control signal, and a discharger configured to discharge leakage current flowing into the internal voltage node through the driver in response to the control signal.

### CROSS-REFERENCE TO RELATED APPLICATIONS

The present invention claims priority to Korean patent application number 10-2008-0113935, filed on Nov. 17, 2008, which is incorporated by reference in its entirety.

### BACKGROUND OF THE INVENTION

The present invention relates to an integrated circuit and, more particularly, to an integrated circuit for generating an internal voltage.

As known, a semiconductor integrated circuit receives an external supply voltage VDD, generates an internal voltage using an internal voltage generator, and supplies the generated internal voltage to an internal circuit of a chip.

FIG. 1 is a block diagram illustrating an internal voltage generator and peripheral devices in an integrated circuit.

Referring to FIG. 1, a reference voltage generator 110 generates a first reference voltage VREF1 and the generated first reference voltage VREF1 is inputted to a first internal voltage generator 120A. The first internal voltage generator 120A generates a first internal voltage VINT1 based on the first reference voltage VREF1.

The reference voltage generator 110 generates a second reference voltage VREF2 and the generated second reference voltage VREF2 is inputted to a second internal voltage generator 120B. The second internal voltage generator 120B generates a second internal voltage VINT2 based on the second reference voltage VREF2.

The first and second internal voltages VINT1 and VINT2 are supplied to an internal circuit 130.

As shown in FIG. 1, a semiconductor integrated circuit may use one internal voltage or more than two internal voltages according to a type of the semiconductor integrated circuit. Therefore, the semiconductor integrated circuit may include one internal voltage generator or more than two internal voltage generators according to a type of the semiconductor integrated circuit.

The internal voltage generators 120A and 120B receive a feed-back internal voltage, compare the feed-back internal voltage with a reference voltage, and control a level of an internal voltage according to the comparison result.

Also, the internal voltage generators 120A and 120B may generate an internal voltage through a pumping operation.

An integrated circuit is mass-produced through a predetermined manufacturing process after the integrated circuit has been designed. The product thereof is tested through a test process for checking quality thereof. Such a test process is generally divided into a wafer level test for a low frequency operation and a package level test for a high frequency operation.

Since a semiconductor device in an end product operates at a high speed, a test process thereof must be matched with a design property of the semiconductor device. However, such a semiconductor device may be determined as being defective in a wafer level test for a low frequency operation.

In addition, power consumption for generating an internal voltage may vary according to frequency. That is, the power consumption for a high frequency is greater than that for a low frequency. This power consumption relationship is the same regardless of a state of a chip, such as an operation state or a standby state.

Therefore, leakage current from an external supply voltage VDD node to an internal voltage VINT node becomes significant at a low frequency operation in a standby-state of an internal voltage generator.

Such a problem will be described in detail with reference to FIGS. 2A and 2B.

FIGS. 2A and 2B are graphs showing a level of an internal voltage VINT according to an external supply voltage in a standby state of an internal voltage generator. FIG. 2A is a graph for a low frequency and FIG. 2B is a graph for a high frequency.

In case of a high frequency, an internal voltage VINT sustains a predetermined design value because current amount for generating the internal voltage VINT is relatively high, although the external power voltage VDD increases.

However, if the external supply voltage VDD increases when it is low frequency, the internal voltage VINT value increases as the external supply voltage VDD increases because the power consumption for generating the internal voltage VDD is smaller than leakage current leaked from the VDD node to the VINT node.

Although the internal voltage generator according to the prior art is designed for a high frequency operation as described above, the internal voltage generator according to the prior art has to perform a low frequency operation during a test process. During the low frequency test, the internal voltage increases due to the leakage current. That is, a chip is deemed to be defective in a low frequency test, although the chip operates normally in an end product. Therefore, a yield of a product is degraded.

### SUMMARY OF THE INVENTION

Embodiments of the present invention are directed to providing an integrated circuit for generating a stable internal voltage in a low frequency operation.

Embodiments of the present invention are also directed to providing an integrated circuit for preventing a product yield from decreasing due to a misjudged defect of an internal voltage generator in a wafer level test mode.

In accordance with an aspect of the present invention, there is provided an integrated circuit including a driver for providing an internal voltage by driving an internal voltage node with an external voltage, a discharger for discharging leakage current flowing into the internal voltage node through the driver, and a controller for controlling driving of the discharger.

In accordance with another aspect of the present invention, there is provided an integrated circuit including an internal voltage generator for generating an internal voltage to an internal voltage node, a controller for generating a control signal having operation frequency information, and a discharger for discharging standby-leakage current flowing into the internal voltage node in a low frequency operation.

In accordance with another aspect of the present invention, there is provided an integrated circuit including a first driver for generating a first internal voltage and providing the generated first internal voltage to a first internal voltage node, a first discharger for discharging leakage current flowing into the first internal voltage node through the first driver, a second driver for generating a second internal voltage and providing the second internal voltage to a second internal voltage output node, a second discharger for discharging leakage current flowing into the second internal voltage node through the second driver, a controller for generating a plurality of control signals, and a decoder for driving the first and second discharges by decoding the plurality of control signals.

In accordance with another aspect of the present invention, there is provided an integrated circuit including a first internal voltage generator for generating a first internal voltage to a first internal voltage node, a second internal voltage generator for generating a second internal voltage to a second internal voltage node, a first discharger for discharging standby-leakage current flowing into the first input node in a low frequency operation, a second discharger for discharging standby-leakage current flowing into the second internal voltage, a controller for generating a plurality of control signals having operation frequency information, and a decoder for driving the first and second dischargers by decoding the plurality of control signals.

### BRIEF DESCRIPTION OF THE DRAWINGS

FIG. 1 is a diagram illustrating an internal voltage generator and peripheral devices in an integrated circuit according to the prior art.

FIGS. 2A and 2B are graphs showing levels of an internal voltage VINT according to an external supply voltage VDD in a standby-state of an internal voltage generator.

FIG. 3 is a block diagram illustrating an integrated circuit in accordance with a first embodiment of the present invention.

FIG. 4 is a block diagram illustrating an integrated circuit in accordance with a second embodiment of the present invention.

FIG. 5 is a circuit diagram illustrating first and second dischargers and a decoder in the integrated circuit of the second embodiment.

FIG. 6 is a circuit diagram illustrating an internal voltage generator in the integrated circuit of the second embodiment shown in FIG. 4.

FIG. 7 is a diagram conceptually illustrating an integrated circuit in accordance with a third embodiment of the present invention.

FIG. 8 is a circuit diagram illustrating an integrated circuit in accordance with a fourth embodiment of the present invention.

FIGS. 9A and 9B are graphs showing levels of an internal voltage VINT according to an external supply voltage VDD in a standby-state in an integrated circuit in accordance to an embodiment of the present invention.

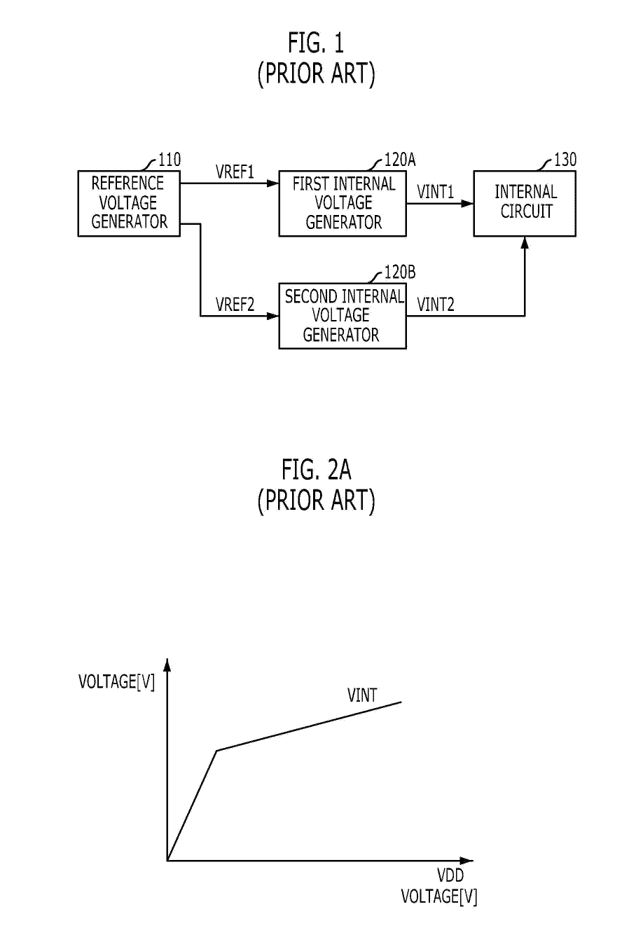

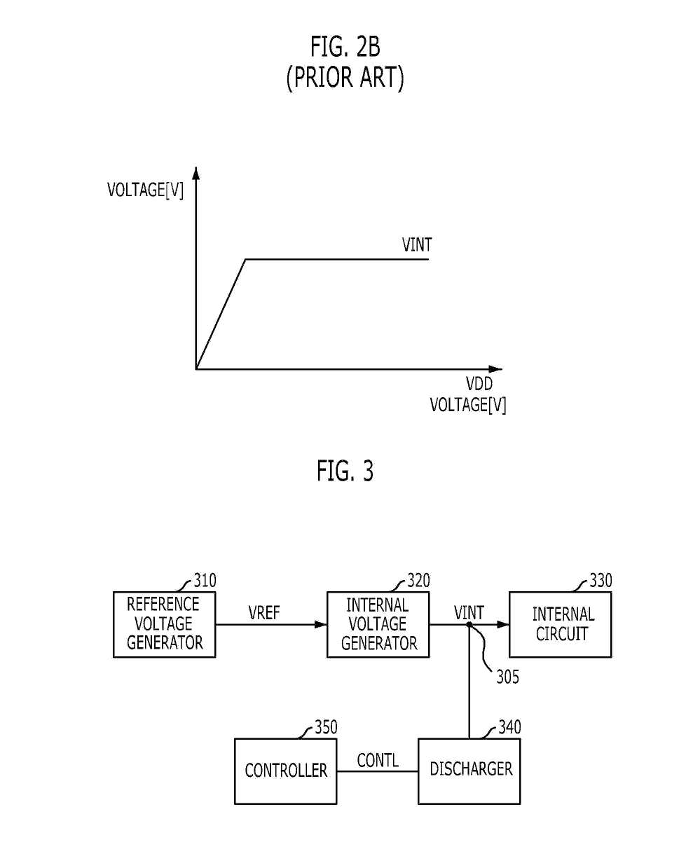

### DESCRIPTION OF SPECIFIC EMBODIMENTS

Other objects and advantages of the present invention can be understood by the following description, and become apparent with reference to the embodiments of the present invention.

FIG. 3 is a block diagram illustrating an integrated circuit in accordance with a first embodiment of the present invention. That is, FIG. 3 shows an integrated circuit that includes an internal voltage generator and uses one internal voltage.

Referring to FIG. 3, the integrated circuit according to the present embodiment includes an internal voltage generator 320, a discharger 340, and a controller 350.

The internal voltage generator 320 generates an internal voltage VINT to an internal voltage node 305. The controller 350 generates a control signal CONTL having operation frequency information. The discharger 340 discharges standby-leakage current flowing into the internal voltage node 305 at a low frequency operation in response to the control signal CONTL.

The discharger 340 may be realized using a transistor that discharges the standby-leakage current of the internal voltage node 305 when the control signal CONTL is activated, that is, in a low frequency operation. The discharger 340 will be described in detail with another embodiment below.

The integrated circuit according to the present embodiment may further include a reference voltage generator 310 for supplying a reference voltage VREF to the internal voltage generator 320 and an internal circuit 330 that receives and uses the internal voltage VINT.

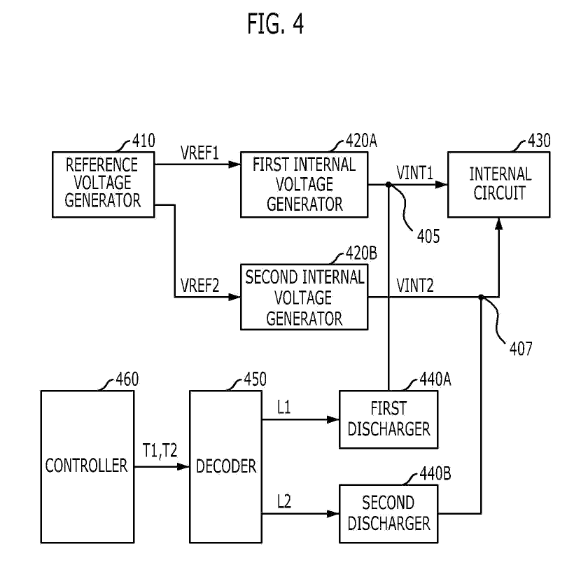

FIG. 4 is a block diagram illustrating an integrated circuit in accordance with a second embodiment of the present invention. That is, FIG. 4 shows an integrated circuit internally using various internal voltages.

Referring to FIG. 4, the integrated circuit according to the second embodiment includes a first internal voltage generator 420A, a second internal voltage generator 420B, a first discharger 440A, a second discharger 440B, a decoder 450, and a controller 460.

The first internal voltage generator 420A generates a first internal voltage VINT1 to the first internal voltage node 405. The second internal voltage generator 420B generates a second internal voltage VINT2 to the second internal voltage node 407. The first discharger 440A discharges a standby-leakage current flowing into the first internal node 405 in a low frequency operation. The second discharger 440B discharges standby-leakage current flowing into the second internal voltage node 407 in a low frequency operation. The controller 460 generates a plurality of control signals T1 and T2 having operation frequency information. The decoder 450 decodes the plurality of control signals T1 and T2 and outputs a plurality of decoded control signals L1 and L2 so that the first and second dischargers 440A and 440B are driven in response to the decoded control signals L1 and L2.

The integrated circuit according to the second embodiment may further include a reference voltage generator 410 and an internal circuit 430. The reference voltage generator 410 provides a first reference voltage VREF1 to the first internal voltage generator 420A and provides a second reference voltage VREF2 to the second internal voltage generator 420B. The internal circuit 430 uses the first and second internal voltages VINT1 and VINT2.

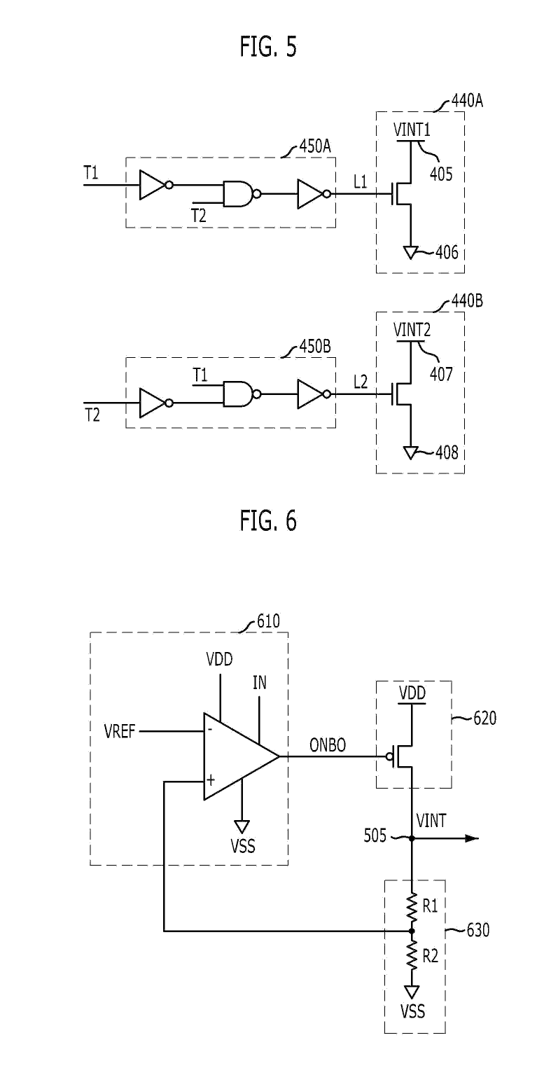

FIG. 5 is a circuit diagram illustrating first and second dischargers and a decoder in the integrated circuit of the second embodiment.

Referring to FIG. 5, the first discharger 440A is formed of a NMOS transistor connected between the first internal voltage node 405 and a predetermined supply voltage end 406, for example, a ground end. The second discharger 440B is also formed of a NMOS transistor connected between a second internal voltage node 407 and a predetermined supply voltage end 408.

The decoder 450 includes a first decoder 450A and a second decoder 450B for decoding control signals T1 and T2 from a controller 460 shown in FIG. 4. The first decoder 450A controls a discharging operation of the first discharger 440A by controlling a gate end of a transistor in the first discharger 440A with a discharge signal L1. The second decoder 450B controls a discharge operation of the second discharger 440B by controlling a gate end of a transistor of the second discharger 440B with a discharge signal L2.

Hereinafter, operation of the circuit shown in FIG. 5 will be described.

In case of a high frequency operation, the first and second dischargers 440A and 440B are disabled.

To be more specific, the control signals T1 and T2 have low values in case of the high frequency operation. Since the signal T2 is a low level, the signal L1 passing through the first decoder 450A has a low level. Since the signal L1 is a low level, a NMOS transistor of the first discharger 440A is turned off, and the first internal voltage node 405 is not discharged to the ground.

Since the control signal T1 is a low level, an output L2 from the second decoder 450B has a low level. Since the signal L2 is a low level, the second discharger 440B is turned off and the second internal voltage node 407 is not discharged to the ground.

Next, a low frequency operation, such as a wafer level test will be described.

If standby-leakage current flows into the first internal voltage node 405, the control signal T1 has a logical low and the control signal T2 has a logical high. Accordingly, the first internal voltage node 405 is discharged by driving the first discharger 440A. In this case, it is necessary to discharge current discharged to ground as much as leakage current flowing into an internal voltage node. That is, the first internal voltage VINT1 does not increase because an external VDD increases in case of low frequency standby. Since the control signal T1 is a low level, the second discharger 440B is disabled. Meanwhile, if the standby-leakage current flows into the second internal voltage node 405, the control signal T1 has a logical high and the control signal T2 has a logical low. Here, only the second discharger 440B is driven.

FIG. 6 is a circuit diagram illustrating an internal voltage generator in the integrated circuits of the first and second embodiments shown in FIGS. 3 and 4.

The internal voltage generator receives a level of an internal voltage through feeding back and compares the received internal voltage level with a reference voltage and drives an internal voltage level according to the comparison result.

However, the present invention is not limited thereto. The internal voltage generator may be formed of a pumping circuit generating an internal voltage through a pumping operation.

The present invention may be applied to any type of internal voltage generator having a circuit structure that receives leakage current (particularly standby-leakage current) through a driver, as described in greater detail below.

Referring to FIG. 6, a comparator 610 receives a reference voltage VREF through one end and receives a feedback signal HALF through the other end. Here, the feedback signal HALF is an output of a divider 630, which is a result of dividing the internal voltage VINT by resistance R1 and R2.

The comparator 610 compares a level of the reference voltage VREF with a level of the feedback voltage HALF and outputs the comparison result. If a signal ONB0 is a low level, that is, if a feedback voltage is smaller than a reference voltage, a PMOS transistor of the driver 620 is turned on. Therefore, an internal voltage VINT of the internal voltage node 605 increases.

If an internal voltage VINT increases, the PMOS transistor is turned off by the comparator. That is, the internal voltage VINT of the internal voltage node 505 does not increase.

Here, the internal voltage generator increases a channel width of the PMOS transistor of the driver to guarantee operation in a low voltage and also minimizes a channel length for enhancing driving ability of a transistor thereof. However, in this case, the internal voltage VINT increases due to leakage current of the PMOS transistor as mentioned above. That is, the leakage current further increases because the higher the external supply voltage VDD increases, the bigger the drain voltage of the PMOS transistor becomes. In order to prevent the leakage current from the increase, the leakage current is discharged through the driver in the present invention.

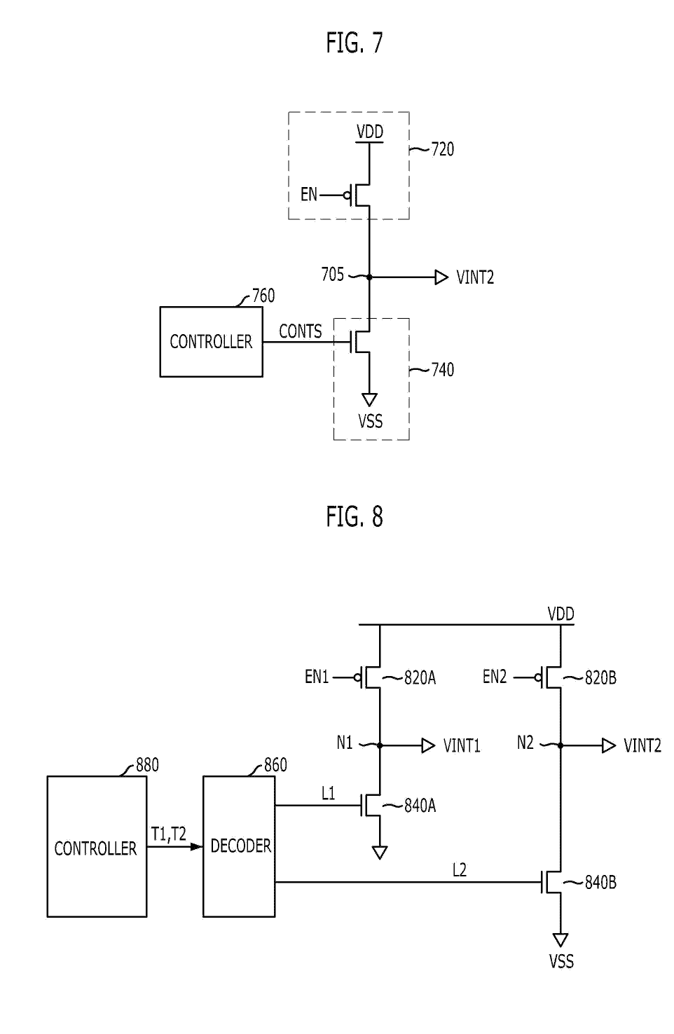

FIG. 7 is a diagram conceptually illustrating an integrated circuit in accordance with a third embodiment of the present invention. That is, FIG. 7 shows a driver and a discharge circuit for discharging leakage current entering through the driver.

Referring to FIG. 7, the integrated circuit according to the present embodiment includes a driver 720, a discharger 740 and a controller 760. The driver 720 provides an internal voltage VINT by driving the internal voltage node 705 with an external voltage VDD. The discharger 740 discharges a leakage current flowing into the internal voltage node 705 through the driver 720. The controller 760 controls an operation of the discharger 740 through a control signal CONTS. The driver 720 is driven by an enable signal EN.

The discharger 740 discharges leakage current flowing into the internal voltage node 705 in a low frequency operation. To discharge, the controller 760 generates a control signal CONTS activated in a low frequency operation and provides the generated control signal CONTS to the discharger 740.

The discharger 740 discharges leakage current flowing into the internal voltage node 705 when the driver 720 is disabled and when an enable signal EN is inactivated to a logical high. For this, the controller 760 generates a control signal CONTS that is activated in a disable state of the driver and provides the generated control signal CONTS to the discharger 740.

The discharger 740 may be formed to discharge standby-leakage current flowing into the internal voltage node in a wafer level test process using a low frequency. For this, the controller 760 may be formed to provide a control signal activated in a wafer level test to a discharger 740.

FIG. 8 is a circuit diagram illustrating an integrated circuit in accordance with a fourth embodiment of the present invention. Unlike the integrated circuit of FIG. 7, the integrated circuit of FIG. 8 uses a plurality of internal voltages.

Referring to FIG. 8, the integrated circuit according to the present embodiment includes a first driver 820A for generating a first internal voltage VINT1 to a first internal voltage node N1, a first discharger 840A for discharging leakage current flowing into the first internal voltage node through a first driver, a second driver 820B for generating a second internal voltage VINT2 and providing the generated second internal voltage VINT2 to the second internal voltage output node N2, a second discharger 840B for discharging leakage current flowing into the second internal voltage node through a second driver, a controller 880 for generating control signals T1 and T2, and a decoder 860 for generating discharge signals L1 and L2 by decoding a plurality of control signals and driving the first and second dischargers using the generated discharge signals L1 and L2.

The first discharger 840A discharges standby-leakage current that flows into an internal voltage node N1 when the driver 820A is disabled, that is, when an enable signal EN1 is inactivated to a logical high.

In order to perform such an operation, the controller 880 and the decoder 860 generate control signals T1 and T2 and discharge driving signals L1 and L2 through the above described circuitry in FIG. 6.

In FIGS. 7 and 8, the dischargers 740, 840A and 840B discharge charges up to an amount of leakage current flowing into the internal voltage node from the external power source VDD. The leakage current amount is decided by the size of the PMOS transistor of the driver. Therefore, a size of a NMOS transistor forming a discharger 740, 840A and 840B may be designed corresponding to the size of the PMOS transistor. It is also possible to design a discharger 740, 840A and 840B to discharge charge after checking an amount of leakage current flowing into an internal voltage node through a test.

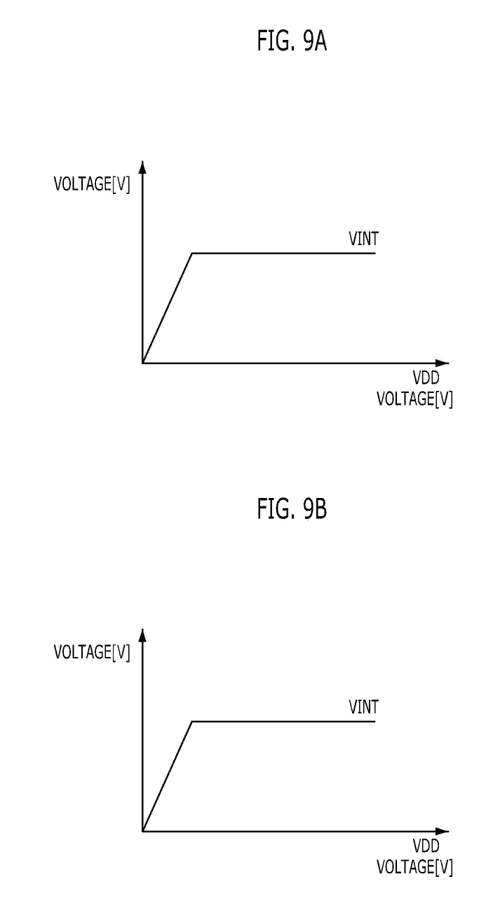

FIGS. 9A and 9B are graphs showing levels of an internal voltage VINT according to an external supply voltage VDD in a standby-state in an integrated circuit in accordance with an embodiment of the present invention. FIG. 9A is a graph for a low frequency, and FIG. 9B is a graph for a high frequency. The high frequency operation denotes that a stable internal voltage is generated not only in a high frequency operation but also in a low frequency operation.

As described above, the integrated circuits according to the embodiments use at least two internal voltages. However, the integrated circuit according to the present invention can stably generate various internal voltages by additionally including a discharger transistor and a decoding circuit, although more than three internal voltages are used.

As described above, the integrated circuit according to the present invention can generate a stable internal voltage by discharging leakage current, such as standby current in a low frequency operation.

Furthermore, the integrated circuit according to the present embodiment can prevent degradation of a product yield because an internal voltage generator is mistakenly decided as being defective in a wafer level test mode.

While the present invention has been described with respect to the specific embodiments, it will be apparent to those skilled in the art that various changes and modifications may be made without departing from the spirit and scope of the invention as defined in the following claims.

What is claimed is:

1. An integrated circuit, comprising:
a driver configured to provide an internal voltage by driving an internal voltage node with an external voltage;
a controller configured to output a control signal; and
a discharger configured to discharge a leakage current flowing into the internal voltage node through the driver in response to the control signal.

2. The integrated circuit of claim 1, wherein the discharger is configured to discharge the leakage current that flows into the internal voltage node in a low frequency operation.

3. The integrated circuit of claim 1, wherein the discharger is configured to discharge the leakage current flowing into the internal voltage at a disable state of the driver.

4. The integrated circuit of claim 1, wherein the discharger is configured to discharge standby-leakage current flowing into the internal voltage node in a wafer level test process.

5. The integrated circuit of claim 1, wherein the discharger is configured to discharge charges up to the leakage current.

6. The integrated circuit of claim 1, wherein the driver and the discharger are formed of a MOS transistor, and a size of the MOS transistor for the discharger is designed corresponding to a size of the MOS transistor for the driver.

7. The integrated circuit of claim 1, wherein the controller is configured to generate a control signal activated in a low frequency operation and to provide the generated control signal to the discharger.

8. The integrated circuit of claim 1, wherein the controller is configured to generate a control signal activated in a disable state of the driver and to provide the generated control signal to the discharger.

9. The integrated circuit of claim 1, wherein the controller is configured to provide a control signal activated in a wafer level test to the discharger.

10. An integrated circuit, comprising:
an internal voltage generator configured to generate an internal voltage to an internal voltage node;
a controller configured to generate a control signal having operation frequency information; and
a discharger configured to discharge standby-leakage current flowing into the internal voltage node in a low frequency operation in response to the control signal.

11. The integrated circuit of claim 10, wherein the internal voltage generator includes a driver for making leakage current flow into the internal voltage node at a standby mode.

12. The integrated circuit of claim 11, wherein the discharger is configured to discharge the leakage current flowing into the internal voltage node at a disable state of the driver.

13. The integrated circuit of claim 10, wherein the discharger is configured to discharge standby-leakage current flowing into the internal voltage node in a wafer level test.

14. The integrated circuit of claim 10, wherein the discharge unit is configured to discharge charges up to the leakage current.

15. The integrated circuit of claim 11, wherein the driver and the discharger are formed of a MOS transistor, and a size of the MOS transistor for the discharger is designed corresponding to a size of the MOS transistor for the driver.

16. The integrated circuit of claim 11, wherein the controller is configured to generate a control signal activated in a disable state of the driver and to provide the generated control signal to the discharger.

17. The integrated circuit of claim 10, wherein the controller is configured to generate a control signal activated in a wafer level test and to provide the control signal to the discharger.

18. An integrated circuit, comprising:
a first driver configured to generate a first internal voltage and to provide the generated first internal voltage to a first internal voltage node;
a first discharger configured to discharge leakage current flowing into the first internal voltage node through the first driver;
a second driver configured to generate a second internal voltage and to provide the second internal voltage to a second internal voltage output node;
a second discharger configured to discharge leakage current flowing into the second internal voltage node through the second driver;
a controller configured to generate a plurality of control signals; and
a decoder configured to decode the plurality of control signals and to output a plurality of decoded control signals so that the first and second dischargers are driven in response to the plurality of decoded control signals.

19. The integrated circuit of claim 18, wherein the first discharger is configured to discharge leakage current flowing into the first internal voltage node in a low frequency operation, and
the second discharger is configured to discharge leakage current flowing into the second internal voltage node in a low frequency operation.

20. The integrated circuit of claim 18, wherein the first discharger is configured to discharge leakage current flowing into the first internal voltage node in a disable state of the first driver, and
the second discharger is configured to discharge leakage current flowing into the second internal voltage node when the second driver is disabled.

21. The integrated circuit of claim 18, wherein the first discharger is configured to discharge leakage current that flows into the first internal voltage node in a wafer level test, and
the second discharger is configured to discharge leakage current flowing into the second internal voltage in a wafer level test.

22. The integrated circuit of claim 18, wherein the first and second dischargers are configured to discharge charges up to an amount of the leakage current flowing into the first and second dischargers.

23. The integrated circuit of claim 18, wherein the first and second drivers and the first and second dischargers are formed of a MOS transistor, and sizes of the MOS transistors for the first and second dischargers are designed corresponding to sizes of the MOS transistors for the first and second drivers.

24. An integrated circuit, comprising:
a first internal voltage generator configured to generate a first internal voltage to a first internal voltage node;
a second internal voltage generator configured to generate a second internal voltage to a second internal voltage node;
a first discharger configured to discharge a standby-leakage current flowing into the first input node in a low frequency operation;
a second discharger configured to discharge a standby-leakage current flowing into the second internal voltage;
a controller configured to generate a plurality of control signals having operation frequency information; and
a decoder configured to decode the plurality of control signals and to output a plurality of decoded control signals so that the first and second dischargers are driven in response to the plurality of decoded control signals.

25. The integrated circuit of claim 24, wherein the first voltage generator includes a first driver for making leakage current to flow into the first internal voltage node in a standby mode, and the second internal voltage generator includes a second driver for making leakage current to flow into the second internal voltage node in a standby mode.

26. The integrated circuit of claim 25, wherein the first discharger is configured to discharge leakage current flowing into the first internal voltage node when the first driver is disabled, and
the second discharger is configured to discharge leakage current flowing into the second internal voltage node when the second driver is disabled.

27. The integrated circuit of claim 24, wherein the first and second dischargers are configured to discharge standby-leakage current, which flows into the first and second internal voltage nodes in a wafer level test operation.

28. The integrated circuit of claim 24, wherein the first and second dischargers are configured to discharge leakage current up to the leakage current.

29. The integrated circuit of claim 24, wherein the first and second drivers and the first and second dischargers are formed of a MOS transistor, and sizes of the MOS transistors for the first and second dischargers are designed corresponding to sizes of the MOS transistors for the first and second drivers.

30. A method for generating an internal voltage, comprising:
generating an internal voltage at an internal voltage node;
making standby-leakage current to flow into the internal voltage node;
generating a control signal having operation frequency information; and
discharging the standby-leakage current in response to the control signal.

31. The method of claim 30, wherein the control signal is activated in low frequency operation.

32. The method of claim 30, wherein the control signal is activated for a wafer level test.

33. A method for generating an internal voltage, comprising:
generating a first internal voltage at a first node and generating a second internal voltage at a second node;
making standby-leakage current to flow into the first node and second node;
generating a plurality of control signals having operation frequency information and test mode information;
generating a first discharge signal and a second discharge signal by decoding a plurality of control signals; and
discharging the standby-leakage current flowing into the first and second nodes in response to the first and second discharge signals.

34. The method of claim 33, wherein at least one of the first discharge signal and the second discharge signal is a wafer level test of a low frequency operation.
